(19) United States
(12) Patent Application Publication
(10) Pub. No.: US 2024/0410162 A1
(43) Pub. Date: Dec. 12, 2024

(54) METHOD AND ARRANGEMENT FOR CURVED CONNECTORS

(71) Applicant: ONX, INC., Carrollton, TX (US)

(72) Inventors: Thulasilingam Mahendran, Tamil Nadu (IN); Pratheep Kumar Rajendran, Austin, TX (US); Mc Gil Domingo Agcaoili, Laoag City (PH); Mohammed Ayad Al-Rufaiey, Dubai (AE)

(73) Assignee: ONX, INC., Carrollton, TX (US)

(21) Appl. No.: 18/208,225

(22) Filed: Jun. 9, 2023

(51) Int. Cl. E04B 1/41; F16B 35/04

(52) U.S. Cl. CPC E04B 1/4157; F16B 35/041

(57) ABSTRACT

A curved connector to connect at least two precast decks includes a curved shaft having opposing first and second ends, and at least one bar anchor for coupling to at least one of the first and second ends and for providing a rigid moment connection between the at least two precast decks of a precast foundation. The curved connector further includes at least one connector bolt for compressing the at least one bar anchor towards a center of the curved shaft.

### FIELD OF THE INVENTION

The present disclosure generally relates to the design and construction of structures, specifically to structures with precast decks used in the construction industry. In particular, the disclosure relates to curved connectors designed for the precast decks.

### BACKGROUND OF THE INVENTION

Existing construction technologies involve one-off (e.g., customized) build-on site approaches in which construction material is brought to a construction site where the actual construction is performed. This has been the traditional methodology and approach for many years but has certain inherent challenges, including non-availability of skilled workforce (e.g., manual labor), heavy and expensive on-site machinery, incorrect estimates of completion times of construction projects, delays in delivery of projects, inclement weather, poor quality and wastage of materials, noise and air pollution, and cost involved in disposal of debris. This approach is also “one-off” as it provides no repeatability or scalability leverage. Each building is constructed, and each project is performed differently, and results vary widely, which may be undesirable considering present day demand for symmetrical construction projects with enhanced look and feel. Furthermore, constructing each individual component of a building on site incurs significant expenditures in time and resources. It also increases a project's vulnerability to unforeseen factors, such as poor weather, worksite accidents, improper pour, etc.

Further, execution of construction projects needs an ensemble of technologies or domains, such as structural integration, civil engineering, mechanical joints, materials science, etc. Although there have been significant advancements in construction technologies, due to the above factors, the average cost of construction and the effective cost of owning a house is still high for most aspiring owners. Therefore, housing still remains beyond the reach of many due to associated construction costs.

In order to address the aforesaid shortfalls of these build-on site approaches, some construction projects use prefabricated building modules. Further, construction methods (used in the completion of construction projects) have been accelerated using prefabricated building modules including precast decks. Precast decks are commonly used at construction sites.

In conventional structures including precast decks, movement of a portion or all the deck or structure may occur as the soil expands or contracts as a result of imposition of loads on an individual pier or footing where the load exceeds the load-bearing capacity of the soil. Independent movement of each footing may generate forces to one or more points of attachment in the deck or foundation support structure. Such movement will often be unevenly distributed, and damage or failure of the deck or structure may occur. Seismic activity may also result in uneven forces being applied to various areas of the deck. If the deck or structure is attached to a building, as is common, the building may also be damaged.

Further, conventional structures using precast decks typically consist of longitudinally spaced concrete precast decks supported by longitudinal load-carrying members. The member or members are usually a single girder or multiple girders. In order to improve deck durability, it is important to apply a pre-compression force across deck joints to minimize the predisposition of the decks to crack under loading. In the event of uneven load application, differential deformation is expected and in order to avoid cracks and joint movement, compression of the joint is required. Conventionally, such pre-compression force is applied via standard post-tensioning systems, which utilize post-tensioning tendons or bars within ducts. Using such conventional post-tensioning systems carries with it the disadvantage of requiring additional cost and time to construct.

Therefore, there remains a need for improved connections between precast decks, i.e., improved connectors that would provide significant improvement in the construction of various structures and buildings utilizing precast prestressed decks and wall panels.

### SUMMARY OF THE INVENTION

Embodiments for designing, constructing, and arranging structures, specifically structures including precast decks in the construction industry that address at least some of the above challenges and issues, are disclosed.

In a first aspect, the present disclosure is directed to a curved connector to connect precast decks of a precast foundation. The curved connector includes a curved shaft having opposing first and second ends, and at least one bar anchor for coupling to at least one of the first and second ends and operable to provide a rigid moment connection between the precast decks of the precast foundation. Further, the curved connector includes at least one connector bolt operable to compress the at least one bar anchor towards a center of the curved shaft.

In some embodiments, the rigid moment connection is provided between the precast decks that are arranged transversely with respect to each other. In some embodiments, a prong of the at least one bar anchor reaches a bottom fiber of the precast decks that facilitates the curved connector to provide the rigid moment connection between the precast decks. In some embodiments, the at least one bar anchor is installed from top of the precast decks emulating bottom reinforcement continuity of the precast decks. In some embodiments, the curved connector provides the rigid moment connection between the precast decks over pre-installed one or more piers. In some embodiments, the pre-installed one or more piers are helical in shape.

In some embodiments, the curved connector secures the precast decks from forces which twist or rotate one precast deck from an adjacent precast deck, and from compression and tension forces.

In a second aspect, the present disclosure is directed to a method for connecting precast decks of a precast foundation utilizing a curved connector. The method includes providing a rigid moment connection, via at least one bar anchor of the curved connector, between the precast decks of the precast foundation. The precast decks are arranged transversely with respect to each other. Further, the method includes applying compressive pressure, via at least one connection bolt of the curved connector, on a grouted joint of the precast decks, where the at least one connector bolt is torqued using at least one nut of the curved connector.

In some embodiments, applying the compressive pressure on the grouted joint of the at least two precast decks includes applying at least a pre-determined pressure to provide shear key resistance and weatherproofing.

In some embodiments, providing the rigid moment connection between the at least two precast decks of the precast foundation includes installing the at least one bar anchor of the curved connector from top of the at least two precast decks emulating bottom reinforcement continuity of the at least two precast decks.

In some embodiments, providing the rigid moment connection between the at least two precast decks of the precast foundation includes securing the at least two precast decks from forces which twist or rotate one precast deck relative to an adjacent precast deck, and from compression and tension forces.

In some embodiments, providing the rigid moment connection between the at least two precast decks of the precast foundation includes providing the rigid moment connection over pre-installed one or more piers. In some embodiments, the pre-installed one or more piers are helical in shape. In some embodiments, the at least two precast decks are prestressed prior to the placement of the at least two precast decks over the pre-installed one or more piers.

In a third aspect, the present disclosure is directed to a deck structure including a precast foundation. The foundation includes a first section having a first surface for supporting a first deck, and a second section having a second surface for supporting a second deck longitudinally spaced from the first deck. In some embodiments, the first and second sections are coupled by a joint. The foundation further includes a curved connector embedded within the first and second sections and extending across the joint, thereby forming a moment connection between the first and second sections.

In some embodiments, the joint is fully grouted. In some embodiments, the curved connector includes: a curved shaft having opposing first and second ends, and first and second bar anchors coupled to the first and second ends, respectively, the first and second bar anchors operable to be forcibly urged towards a center of the curved shaft, thereby compressing the joint. In some embodiments, the deck structure further includes first and second nuts, the first and second ends being threaded for receiving the first and second nuts, respectively, such that when the first and second nuts are torqued, the first and second bar anchors are urged towards each other. In some embodiments, openings from the first and second surfaces to the first and second ends are fully grouted. In some embodiments, each of the first and second bar anchors includes a corresponding plate coupled to the curved shaft by a corresponding one of the first and second nuts, one or more prongs that extend from the plate at an oblique angle to the first and second surfaces, each of the one or more prongs having a foot that extends substantially parallel to the first and second surfaces. In some embodiments, the foundation further includes fiber concrete. In some embodiments, the grout bulges at an intersection of the curved shaft and the joint. In some embodiments, each of first and second plates are embedded within the foundation at four quadrants.

In some embodiments, the foundation further includes a shear key opposite the first and second surfaces.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates a side cross-sectional view of a curved connector embedded in a foundation, in accordance with some embodiments of the present disclosure.

FIG. 2 illustrates a top cross-sectional view of the curved connector of FIG. 1 embedded in the foundation, in accordance with some embodiments of the present disclosure.

FIG. 3 illustrates the components of the bar anchor, in accordance with some embodiments of the present disclosure.

FIG. 4 illustrates the components of a curved connector, in accordance with some embodiments of the present disclosure.

FIG. 5 illustrates the steps of a method for arranging a curved connector in a foundation, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown, but is to be accorded the widest possible scope consistent with the principles and features disclosed herein.

With modernization in construction-related methodologies and technologies, there has been a rapid shift from normal customized build on-site construction methodologies to construction using modules or blocks that may be built off-site. However, in such an approach, the modules especially precast decks need to be connected in such a manner that they improve deck durability.

Further, in conventional precast decks, movement of a portion or all the deck may occur as the soil expands or contracts during different times in a year as a result of imposition of loads on an individual pier or footing where the load exceeds the load-bearing capacity of the soil. Such movement will often be unevenly distributed, and damage or failure of the deck may occur. Therefore, in order to improve the durability of the decks, it is important to have improved connections across joints in the precast decks.

In particular, conventional construction methodologies and technologies fail to provide durable decks and require additional cost and time to construct. The embodiments of the present disclosure describe improved and better-quality connectors, i.e., curved connectors that solve the concerns of conventional construction methodologies and provide other benefits discussed in detail below.

The present disclosure proposes the use of an improved curved connector in the construction industry for joining adjacent precast decks in a side-to-side or an edge-to-edge relationship. A person of ordinary skill in the art will understand that this relationship is non-exhaustive, and several other possibilities do exist. By leveraging such curved connectors, the present disclosure ensures quality, cost reduction, utility, and easy installation at a construction site.

The disclosed solution provides several other objects and advantages some of which are discussed below. The present disclosure supports rapid construction of a structure including precast (prefabricated) decks accommodating erratic site constraints and/or tight construction schedules. Further, the present disclosure provides at least pre-compression forces across joints between precast decks, thus improving the durability of precast decks. Furthermore, an increase in the load resistance of the structure (including the precast decks) may be obtained by means of the present disclosure. At the least, this increase makes the structure sturdier. In addition, in the present disclosure, post-tension forces are generated external to the precast decks. This makes the structure economical and helps shorten the construction cycle. This also significantly improves the global integrity, provides moment resistance in a transverse direction, improves shear capacity of the joints between precast decks, and provides water-tight joints. Advantageously, unlike prior art foundations in which connectors can only be accessed through hard-to-reach bottom portions of the foundation, in accordance with some embodiments, connectors are able to be accessed from the top of the foundation. Thus, the bottom tensile strength of the foundation can be provided/increased to the joint by accessing it from the top of the foundation, simplifying construction and maintenance. Further, having precast foundations (including the precast decks) eliminates the need to excavate the construction site, prepare and trench ground soil, erect a moisture barrier (since the foundation is not in contact with the soil), prepare and install steel and concrete finishing, and provide smoothing, among other like benefits.

Certain terms and phrases have been used throughout the disclosure and will have the following meanings in the context of the ongoing disclosure.

“Precast decks” refer to decks that are one of the most used precast (prefabricated) decks. Within a system that employs such decks, a deck is poured and cast in sections before being delivered and installed at a construction site.

“Curved connectors” refer to connectors, in accordance with embodiments, between precast decks to transfer interface shear and achieve the desired action that at least includes increasing the load resistance of a construction structure.

“Grout” refers to a dense fluid which is used to fill gaps or used as reinforcement in existing structures. Grout is generally a mixture of water, cement, and sand, and is employed in pressure grouting, connecting sections of precast concrete, filling voids, embedding rebar in masonry walls, and sealing joints such as those between tiles, and the like.

“Piers” refer to pillars or platforms supported by pillars made preferably of steel, such as screw-in pilings and ground anchoring systems used for building deep foundations. Screw piers are typically manufactured from high-strength steel using varying sizes of tubular hollow sections. Screw piers are also referred to as screw piles, screw anchors, screw foundations, ground screws, helical piles, helical piers, helical anchors, and the like.

In accordance with some embodiments, the present disclosure is directed to a curved connector for connecting precast decks of a precast foundation. Decks are not limited to precast decks, and may include any other type of decks as is known to a person of ordinary skill in the art. The curved connector includes a curved shaft having opposing first and second ends, and at least one bar anchor for coupling to at least one of the first and second ends and for providing a rigid moment connection between the precast decks. The curved connector further includes at least one connector bolt for compressing the at least one bar anchor towards a center of the curved shaft. In some embodiments, the precast decks include fiber reinforced concrete.

In some embodiments, the rigid moment connection is provided between the at least two precast decks that are arranged transversely with respect to each other.

In some embodiments, a prong of the at least one bar anchor reaches a bottom fiber of the at least two precast decks that facilitates the curved connector to provide the rigid moment connection between the at least two precast decks.

In some embodiments, the curved connector secures the at least two precast decks from forces which twist or rotate one precast deck from an adjacent precast deck, and from compression and tension forces.

In some embodiments, the curved connector provides the rigid moment connection between the at least two precast decks over pre-installed one or more piers, and the pre-installed one or more piers are helical in shape.

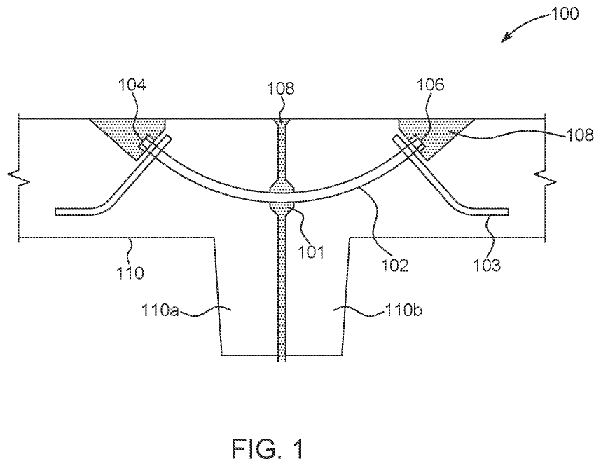

These and other embodiments of the present disclosure are described in detail with reference to FIGS. 1-5.

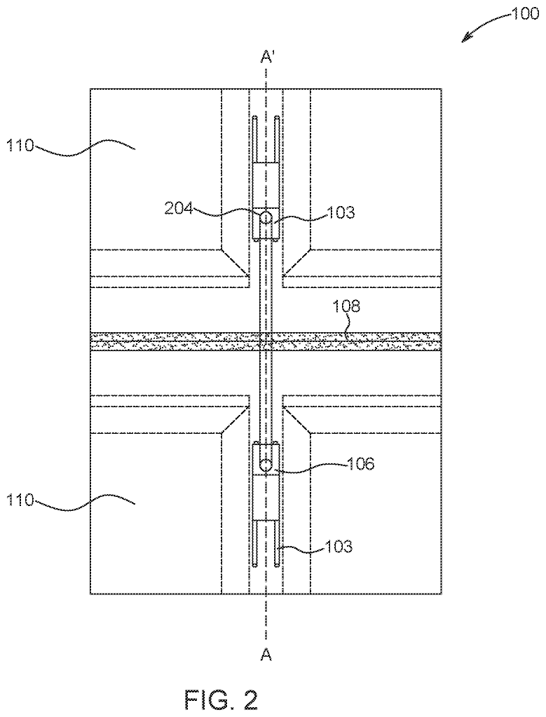

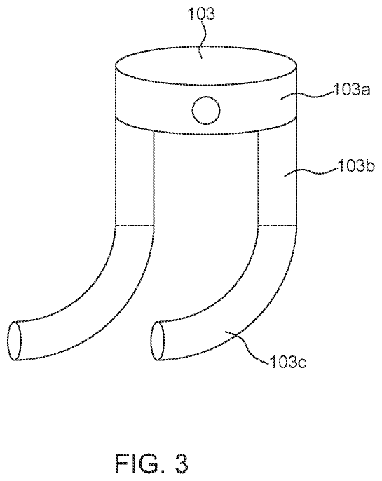

FIG. 1 illustrates an arrangement 100 including a curved connector 101 embedded within a precast foundation 110 in accordance with some embodiments. FIG. 1 illustrates a side cross-sectional view of the arrangement 100 along the line A-A′ in FIG. 2. In some embodiments, the curved connector 101 includes a curved shaft or rod 102 terminated at opposite ends by bolts 104, nuts 106 operable to screw/fasten onto the bolts 104, and bar anchors 103, each bar anchor 103 including a fastening plate 103A, having a hole, one or more prongs 103B extending therefrom, each prong 103B ending in a curved foot 103C (the fastening plate 103A, the one or more prongs 103B, and the curved foot 103C are depicted in FIG. 3). The precast foundation 110 includes a left section 110A coupled to a right section 110B by a fully grout joint 108. The fully grout joint 108 bulges where the shaft 102 crosses or intersects it. In some embodiments, an amount of curvature (of the curved connector 101) may be required to be an optimum amount of curvature that may be chosen based at least in part on one or more of: at least one property of the structure (that is to be designed and constructed) and at least one element associated with the structure. In some embodiments, the amount of curvature (of the curved connector 101) may be based at least in part on a depth of the precast foundation 110.

Referring to FIG. 1, the bar anchors 103 may be separate from concrete structural elements making up a construction structure. Alternatively, in some embodiments, the bar anchors 103 may be embedded into the concrete structural elements as they are formed. The bar anchors 103 may be formed from a sheet of metal stock. In some embodiments, the sheet preferably includes steel. The enhancement provided by the structure of the bar anchors 103 is with respect to the “stressing” of the curved connector 101 within the concrete construction structure. The bar anchors 103 may be formed using known cutting and stamping techniques. In some embodiments, the bar anchors 103 may include 12 mm thick steel plates and may have fully weld bar anchors with a diameter of 12 mm. It will be apparent to a person skilled in the art that any number of bar anchors 103 may be installed in a given arrangement as required based on constructional requirements. Further, a person of ordinary skill in the art will understand that other configurations and dimensions are also possible for the bar anchors 103.

In some embodiments, each of the bar anchors 103 may include a corresponding fastening plate 103A coupled to the curved shaft 102 by a corresponding one of the nuts 106. Further, one or more prongs 103B may extend from the fastening plate 103A at an oblique angle (e.g., 45 degrees) to the surface of the precast foundation 110, and each of the one or more prongs 103B may have a foot 103C that extends substantially parallel to the surface of the precast foundation 110. Further, in some embodiments, the fastening plate 103A may be substantially orthogonal to the curved shaft 102 where they couple, at an oblique angle (e.g., 45 degrees) to the surface of the precast foundation 110, and the curved feet 103C may be substantially parallel to the surface of the precast foundation 110.

Referring to FIG. 1, as the bolts 104 are torqued, they may apply compressive pressure on a grouted joint of the fully grout 108 providing excellent shear key resistance and weatherproofing. In some embodiments, the generated torque may be 237.557 Nm. In some embodiments, the bolts 104 may be galvanized and waxed, and may have a diameter of 20 mm. A person of ordinary skill in the art will understand that other configurations and dimensions are also possible for the bolts 104.

Further, referring to FIG. 1, the nuts 106 may be used to torque the bolts 104. The arrangement of nuts 106 and bolts 104 provide excellent shear key resistance and weatherproofing. In some embodiments, the nuts 106 may be galvanized and waxed, and may have a diameter of 20 mm. A person of ordinary skill in the art will understand that other configurations and dimensions are also possible for the nuts 106.

In some embodiments, once precast decks of the precast foundation 110 are installed, the curved connectors 101 are made composite at least with the bar anchors 103, the bolts 104, and the nuts 106 by grouting voids (and thus forming fully grout 108) in the curved connectors 101 relative to the precast decks. Before the process of grouting, the nuts 106 are tightened against the bar anchors 103 in conjunction with the stressing operations to lock in the stress and to prevent cracking of the precast decks under different loads.

In some embodiments, the precast foundation 110 acts as a foundation on which all the above-discussed non-exhaustive elements (the bar anchors 103, the bolts 104, the nuts 106, and the fully grout 108) are installed. In some embodiments, the precast foundation 110 preferably includes steel and concrete. In some embodiments, the precast foundation 110 includes a plurality of piers and one or more precast prestressed decks (not shown). In some embodiments, the precast decks are prestressed making the decks, and as such, the precast foundation 110, more durable. A person of ordinary skill in the art will understand that other configurations and shapes/scenarios are also possible for the precast foundation.

Referring to FIG. 1, the curved connector 101, as described above, provides stability to the precast foundation 110 by connecting the precast decks. In some embodiments, the curved connector 101 further provides rigidity to a grouted joint of the precast decks in case of differential settlements of the precast foundation 110.

In some embodiments, the curved connector 101 provides rigid moment connection between the precast decks that are placed or mounted transversely with respect to each other. This is achieved with a prong 103B of the bar anchor 103 that reaches a bottom fiber of the connected precast decks. In some embodiments, the bar anchor 103 is installed from a top of the connected precast decks, emulating bottom reinforcement continuity of the connected precast decks.

In some embodiments, the curved connector 101 provides rigid moment connection between transverse precast decks over pre-installed piers. A person of ordinary skill in the art will understand that piers, also known as anchors, piles, screw foundations, ground screws, helical piles, helical piers, helical anchors, screw piles, or the like, are foundation solutions used to secure new or repair existing foundations. Such installation of the plurality of piers in a ground surface minimizes the installation time and requires little or no soil preparation.

In some embodiments, the curved connector 101 secures the precast decks from forces that twist or rotate one precast deck relative to an adjacent precast deck, and from compression and tension forces.

Thus, FIG. 1 illustrates the curved connector 101 extending from the first section 110A, over the fully grouted joint 108, to the second section 110B, thereby coupling the first and second sections 110A and 110B over the joint 108, in accordance with some embodiments of the present disclosure. Such an arrangement ensures a longer lifespan of the construction structure, requires less maintenance, has limited possibility of corrosion, has limited possibility of cracking, and provides other like benefits. Therefore, use of curved connectors (for e.g., the curved connector 101) for joining precast decks, and as such, laying the precast foundation, prevents lateral movement and undue settling of the precast foundation, thereby preventing damage to the precast foundation, and in turn, to the construction structure. The curved connector 101 is durable, weatherproof, etc., and overcomes the concerns and problems of conventional solutions.

FIG. 2 illustrates a top cross-sectional view of the arrangement 100 in accordance with some embodiments of the present disclosure. FIG. 2 will be explained in conjunction with the description of FIG. 1.

Referring to FIG. 2, the curved connector 101 includes bar anchors 103, bolts 104, nuts 106, and fully grout 108. Further, the arrangement 100 includes a precast foundation 110. Herein, the bar anchors 103, the bolts 104, the nuts 106, the fully grout 108, and the precast foundation 110 are described in detail through the description of FIG. 1, and therefore, each functionality with respect to these structural elements may not be described extensively again for the sake of brevity.

As discussed above, the bar anchors 103 may be separate from concrete structural elements making up a construction structure. Alternatively, in some embodiments, the bar anchors 103 are embedded into the concrete structural elements as they are formed. It will be apparent to a person skilled in the art that any number of bar anchors 103 may be installed in a given arrangement as required based on constructional requirements.

Further, as the bolts 104 are torqued using the nuts 106, the bolts 104 may apply compressive pressure on a grouted joint of the fully grout 108 providing excellent shear key resistance and weatherproofing. In particular, the arrangement of nuts 106 and bolts 104 provide excellent shear key resistance and weatherproofing.

Referring to FIG. 2, once precast decks of the precast foundation 110 are installed, the curved connectors 101 are integrated at least with the bar anchors 103, the bolts 104, and the nuts 106 by grouting voids (and thus forming fully grout 108) in the curved connectors 101 relative to the precast decks. Before the process of grouting, the nuts 106 are tightened against the bar anchors 103 in conjunction with the stressing operations to lock in the stress and to prevent cracking of the precast decks under different loads.

FIG. 3 illustrates the components of the bar anchor 103 in accordance with some embodiments. FIG. 3 will be explained in conjunction with the descriptions of FIGS. 1 and 2. The bar anchor 103 includes a fastening plate 103A, having a hole, one or more prongs 103B extending therefrom, each prong 103B ending in a curved foot 103C. Herein, the fastening plate 103A, the one or more prongs 103B, and the curved foot 103C are described through the description of FIGS. 1 and 2 and therefore, each functionality with respect to these structural elements are not described extensively again for the sake of brevity.

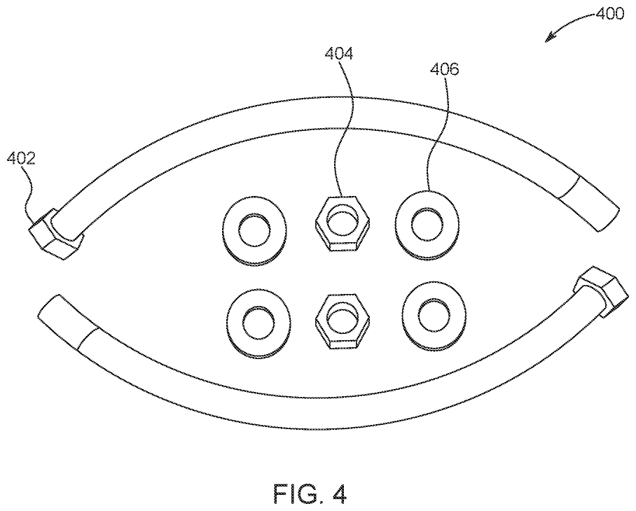

FIG. 4 illustrates the components of a curved connector 400 in accordance with some embodiments. FIG. 4 will be explained in conjunction with the descriptions of FIGS. 1-3. The curved connector 400 includes bolts 402, nuts 404, and washers 406. Herein, the bolts 402 and the nuts 404 may be equivalent to respective bolts 104 and nuts 106 of FIGS. 1 and 2 in their functionality, as described above. Therefore, each functionality with respect to these structural elements are not described extensively again for the sake of brevity.

Referring to FIG. 4, the curved connector 400 includes bolts 402. In some embodiments, the bolts 402 may be galvanized and waxed, and may have a diameter of 20 mm. A person of ordinary skill in the art will understand that other configurations and dimensions are also possible for the bolts 402.

Further, the curved connector 400 includes nuts 404 that may be used to torque the bolts 402. The arrangement of nuts 404 and bolts 402 provides excellent shear key resistance and weatherproofing. In some embodiments, the nuts 404 may be galvanized and waxed, and may have a diameter of 20 mm. A person of ordinary skill in the art will understand that other configurations and dimensions are also possible for the nuts 404.

Referring to FIG. 4, the curved connector 400 includes washers 406. A person of ordinary skill in the art will understand that a washer is a small flat ring fixed between a nut and a bolt, such as between nut 404 and bolt 402. A washer 406 ensures tightness and acts as a seal.

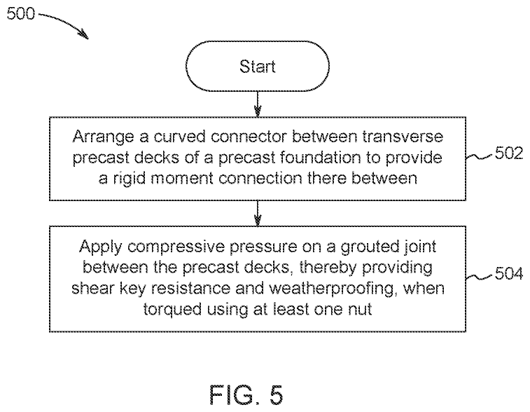

FIG. 5 illustrates a flowchart specifying the steps of a method 500 for arranging a curved connector in a precast foundation (to connect precast decks), in accordance with some embodiments. The curved connector described herein may be equivalent to curved connectors of FIGS. 1-4 in its functionality, as described above.

Although specific operations are disclosed in FIG. 5, such operations are examples and are non-limiting. In different embodiments, to name only a few examples, the method 500 includes other steps, the sequence of the steps is modified, some steps are omitted, or any combination of these variations may be incorporated. The steps of the method 500 may be automated or semi-automated. In various embodiments, one or more of the operations of the method 500 may be controlled or managed by software, by firmware, by hardware, or by any combination thereof, but is not limited to such. Further, FIG. 5 will be explained in conjunction with the descriptions of FIGS. 1-4.

Referring to FIG. 5, the method 500 includes processes in accordance with the present disclosure which may be controlled or managed by a processor(s) and electrical components under the control of a computer or computing device comprising computer-readable media containing computer-executable instructions or code. The readable and executable instructions (or code) may reside, for example, in data storage such as volatile memory, non-volatile memory, and/or mass data storage, as only some examples. As explained later, in some embodiments, automation of the method 500 through a computer employs various peripherals such as sensors, robotic arms, etc.

Referring to FIG. 5, at step 502, a curved connector 101 is arranged between transverse precast decks of a precast foundation 110 to provide a rigid moment connection therebetween. In some embodiments, the rigid moment connection is provided between the transverse precast decks via at least one bar anchor 103 of the curved connector 101. In some embodiments, the precast decks are joined transversely with each other through at least one of the curved connectors 101, a plurality of box connectors, and a plurality of iron bars. In some embodiments, the precast decks are fixed with a precast angle plate and curved connectors 101, lifting, and cast-in items. In some embodiments, an optimum number of spacers with the correct sizes are properly placed and secured to achieve the required concrete cover during casting of the precast decks. In some embodiments, the curved connector 101 is prepared based on a predefined length needed for construction structure. For such purposes, the curved connector 101 is bent based on a predefined construction specification.

Referring to FIG. 5, at step 504, the method 500 includes applying compressive pressure on a grouted joint 108 of the precast decks, thereby providing shear key resistance and weatherproofing, where the at least one connector bolt 104 is torqued using at least one nut 106 of the curved connector 101. Thus, the curved connector 101 provides shear key resistance and weatherproofing which is not obtained using conventional solutions.

In some embodiments, the precast foundation 110 is included in a deck structure. The foundation 110 may include a first section having a first surface for supporting a first deck, and a second section having a second surface for supporting a second deck longitudinally spaced from the first deck. The first and second sections may be coupled by a joint. The foundation 110 may further include a curved connector 101 embedded within the first and second sections and extending across the joint, thereby forming a moment connection between the first and second sections.

In some embodiments, a system (e.g., a computer) for performing the steps of the method 500 is automated. Preferably, the computer includes a memory storing computer-executable instructions that when executed by a processor perform the steps of method 500.

With reference to the aspects disclosed in FIGS. 1-5, in some embodiments, joining methodologies and technologies (e.g., the curved connectors) are used to join sub-modules/sub-units of individual building blocks or to join one building block with another. For example, some joining methodologies and/or technologies are used to build modular building blocks that when assembled make a building envelope/enclosure structurally and environmentally seamless. In another example, some interconnection methodologies are used between components, such as foundation and wall of a construction project; wall and wall of a construction project; wall-to-wall and floor level slabs of a construction project, wall and roof trusses of a construction project; and roof trusses of a construction project. In yet another example, some interconnection methodologies are used that speed up assembly processes and reduce the need for skilled labor. In yet another example, some interconnection technologies are used that allow a high degree of module completion in the factory or at an off-site location. In yet another example, digitization of modular building blocks enables repeatability with higher quality levels than traditional methodologies.

The terms “comprising,” “including,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention. The term “connecting” includes connecting, either directly or indirectly, and “coupling,” including through intermediate elements. The term “may” includes, among another things, “is able to,” “can,” and “is capable of.”

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein may be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the building blocks described herein contain optional features that may be individually or together applied to any other embodiment shown or contemplated here to be mixed and matched with the features of that building block.

While the invention has been described with respect to a limited number of embodiments, those skilled in the art, having benefit of this disclosure, will appreciate that other embodiments may be devised which do not depart from the spirit and scope of the invention as disclosed herein.

We claim:

1. A curved connector to connect at least two precast decks of a precast foundation, the curved connector comprising:
a curved shaft having opposing first and second ends;
at least one bar anchor for coupling to at least one of the first and second ends and configured to provide a rigid moment connection between the at least two precast decks of the precast foundation; and
at least one connector bolt configured to compress the at least one bar anchor towards a center of the curved shaft.

2. The curved connector of claim 1, wherein the rigid moment connection is provided between the at least two precast decks that are arranged transversely with respect to each other.

3. The curved connector of claim 1, wherein a prong of the at least one bar anchor reaches a bottom fiber of the at least two precast decks that facilitates the curved connector to provide the rigid moment connection between the at least two precast decks.

4. The curved connector of claim 1, wherein the curved connector is configured to secure the at least two precast decks from forces which twist or rotate one precast deck from an adjacent precast deck, and from compression and tension forces.

5. The curved connector of claim 1, wherein the curved connector is configured to provide the rigid moment connection between the at least two precast decks over pre-installed one or more piers, and wherein the pre-installed one or more piers are helical in shape.

6. A method for connecting at least two precast decks of a precast foundation, the method comprising:
providing a rigid moment connection, via at least one bar anchor of a curved connector, between the at least two precast decks of the precast foundation, wherein the at least two precast decks are arranged transversely with respect to each other; and
applying compressive pressure, via at least one connector bolt of the curved connector, on a grouted joint of the at least two precast decks, wherein the at least one connector bolt is torqued using at least one nut of the curved connector.

7. The method of claim 6, wherein applying the compressive pressure on the grouted joint of the at least two precast decks comprises applying at least a pre-determined pressure to provide shear key resistance and weatherproofing.

8. The method of claim 6, wherein providing the rigid moment connection between the at least two precast decks of the precast foundation comprises installing the at least one bar anchor of the curved connector from top of the at least two precast decks emulating bottom reinforcement continuity of the at least two precast decks.

9. The method of claim 6, wherein providing the rigid moment connection between the at least two precast decks of the precast foundation comprises securing the at least two precast decks from forces that twist or rotate one precast deck relative to an adjacent precast deck, and from compression and tension forces.

10. The method of claim 6, wherein providing the rigid moment connection between the at least two precast decks of the precast foundation comprises providing the rigid moment connection over pre-installed one or more piers.

11. The method of claim 10, wherein the pre-installed one or more piers are helical in shape.

12. The method of claim 10, wherein the at least two precast decks are prestressed prior to the placement of the at least two precast decks over the pre-installed one or more piers.

13. A deck structure comprising:
a foundation comprising:
a first section having a first surface configured to support a first deck;
a second section having a second surface configured to support a second deck longitudinally spaced from the first deck, the first and second sections coupled by a joint; and
a curved connector embedded within the first and second sections and extending across the joint, thereby forming a moment connection between the first and second sections.

14. The deck structure of claim 13, wherein the joint is fully grouted.

15. The deck structure of claim 14, wherein the curved connector comprises:
a curved shaft having opposing first and second ends; and
first and second bar anchors coupled to the first and second ends, respectively, the first and second bar anchors configured to be forcibly urged towards a center of the curved shaft, thereby compressing the joint.

16. The deck structure of claim 15, further comprising first and second nuts, wherein the first and second ends are threaded for receiving the first and second nuts, respectively, such that when the first and second nuts are torqued, the first and second bar anchors are urged towards each other.

17. The deck structure of claim 16, wherein openings from the first and second surfaces to the first and second ends are fully grouted.

18. The deck structure of claim 16, wherein each of the first and second bar anchors comprises a corresponding plate coupled to the curved shaft by a corresponding one of the first and second nuts, one or more prongs that extend from the plate at an oblique angle to the first and second surfaces, each of the one or more prongs having a foot that extends substantially parallel to the first and second surfaces.

19. The deck structure of claim 16, wherein the foundation further comprises fiber concrete.

20. The deck structure of claim 16, wherein the grout bulges at an intersection of the curved shaft and the joint.

21. The deck structure of claim 18, wherein each of first and second plates are embedded within the foundation at four quadrants.

22. The deck structure of claim 15, wherein the foundation further comprises a shear key opposite the first and second surfaces.
